(19) United States
(12) Patent Application Publication
(10) Pub. No.: US 2020/0126274 A1
(43) Pub. Date: Apr. 23, 2020

(54) CHINESE CHARACTER INFORMATION RECORDING METHOD

(71) Applicant: Guangsheng Lin, Guangzhou (CN)

(72) Inventor: Guangsheng Lin, Guangzhou (CN)

(21) Appl. No.: 16/718,197

(22) Filed: Dec. 18, 2019

Related U.S. Application Data
(63) Continuation of application No. 15/037,326, filed on May 26, 2016.

(51) Int. Cl. G06T 11/20; G09B 19/06; G09B 5/12; G06K 9/00; G06F 3/01; G09B 11/00; G06F 3/023

(52) U.S. Cl. CPC G06T 11/20; G09B 19/06; G09B 5/125; G06F 3/023; G06F 3/018; G09B 11/00; G06F 3/0233; G06K 9/00402

(57) ABSTRACT

The present invention provides a Chinese character information recording method and a Chinese character stroke order recognition figure in an information recording method. A Chinese character structure is split into several parts step by step according to a simplicity rule in the Chinese character information recording method, and the several parts are sequenced, so as to recognize an approximate stroke order of the Chinese character structure. Similarly, approximate stroke orders of most Chinese characters can be recognized. With reference to a special situation table of a Chinese character stroke order, a step of recognizing a stroke of a Chinese character, and a step of recording a Chinese character by using an information recording tool according to a stroke order, most Chinese characters can be recorded successfully, thereby helping a beginner of the Chinese character to shorten time for successfully recording a Chinese character. Approximate stroke orders of most Chinese characters can be recognized simply by using the Chinese character stroke order recognition figure.

### CROSS-REFERENCE TO RELATED APPLICATIONS

This is a continuation of application Ser. No. 15/037,326, filed on May 26, 2016, which is a national application of PCT/CN2013/089901, filed on Dec. 18, 2013. All of the foregoing applications are hereby incorporated herein by reference in their entirety.

### FIELD OF THE INVENTION

The present application relates to an information recording method, and more particularly, to a Chinese character information recording method which records Chinese characters by using an information recording apparatus and which belongs to the IPC: G11B; and a diagram device for teaching which teaches to determine Chinese character stroke orders and which belongs to the IPC: G09B 29/00.

### BACKGROUND OF THE INVENTION

Information recording is a foundation of social civilization. In order to realize information recording under different conditions or improve the efficiency of information recording under the same conditions (for example, the information recording under water, the information recording under the condition of losing gravity.), a large number of information recording devices, carriers, and methods which are mentioned in the Table of International Patent Classification are invented.

The present application is an improvement invention that improves a basic step included in existing Chinese character information recording technologies.

Englishman Tom has got his tablet computer. He has no contact with Chinese characters. If he wants to record Chinese characters smoothly on his tablet computer, he will need to go through such a process: a step for determining Chinese character strokes, a step for determining Chinese character stroke orders, and a step for recording Chinese characters according to the Chinese character stroke orders by using his tablet computer. (Using a tablet computer or other information recording apparatuses includes their operation process.)

The second step (the step for determining Chinese character stroke orders) is a tedious and lengthy step. (In general, a Chinese character is composed of Chinese character structures; a Chinese character structure is composed of subordinate Chinese character structures; to the last, a Chinese character structure is composed of strokes; so a Chinese character is composed of strokes. Each Chinese character is equivalent to a graphic which is composed of strokes. In order to record Chinese characters smoothly, people take a method which sets down the order of every stroke of each Chinese character. This is the Chinese character stroke order method. “Stroke order” is “Chinese character stroke order” for short.) At present, after having learned Chinese for 9 years (including Elementary School and Junior High School), Chinese domestic students can record 7,000 commonly-used Chinese characters according to correct stroke orders. People outside of China need a longer time.

If there is a way that can make Chinese character beginners who have no contact with Chinese characters to complete the second step within a few months just needing to know gaps, potential gaps, vertical lines, horizontal lines, and turning lines, it will help Chinese character beginners greatly reduce the difficulty and shorten the time of realizing to record Chinese character information smoothly according to Chinese character stroke orders by using an information recording apparatus.

### DISCLOSURE

### Technical Problem

The present application is to improve a basic step included in existing Chinese character information recording technologies; thus helps Chinese character beginners reduce the difficulty and shorten the time of realizing to record Chinese character information smoothly according to Chinese character stroke orders by using an information recording apparatus.

### Technical Solution

The present application provides the following solution:

A Chinese character information recording method comprises a step for determining Chinese character strokes, a step for determining Chinese character stroke orders, and a step for recording Chinese characters according to the Chinese character stroke orders by using an information recording apparatus. The step for determining Chinese character stroke orders comprises a step for determining Chinese character stroke orders according to a Chinese character stroke order quickly determining method and a step for determining Chinese character stroke orders by reference to a table of Chinese character stroke order special situation.

The Chinese character stroke order quickly determining method comprises comparing a Chinese character structure with a split method from the first split rule of a sequence of split rules of the split method to the last split rule of the sequence of split rules of the split method and splitting the Chinese character structure into two parts according to the first suitable split rule of the sequence of split rules of the split method; comparing each of the two parts with the split method from the first split rule of the sequence of split rules of the split method to the last split rule of the sequence of split rules of the split method and splitting each of the two parts into two parts according to the first suitable split rule of the sequence of split rules of the split method; and so on, until the Chinese character structure cannot be continued to split according to the split method; wherein the split method comprises a sequence of split rules:

Split rule A. if a Chinese character structure contains a vertical gap which can be run through, obtaining a vertical line to run through the vertical gap of the Chinese character structure, the left part of the vertical line being a first recording part, the right part of the vertical line being an after recording part;

Split rule B. if a Chinese character structure contains a horizontal gap which can be run through, obtaining a horizontal line to run through the horizontal gap of the Chinese character structure, the above part of the horizontal line being a first recording part, the below part of the horizontal line being an after recording part;

Split rule C. if a Chinese character structure contains a turning gap which can be run through, obtaining a turning line to run through the turning gap of the Chinese character structure, the outside part of the turning line being a first recording part, the inside part of the turning line being an after recording part;

Split rule D. if a Chinese character structure contains a turning potential gap which can be run through, obtaining a turning line to run through the turning potential gap of the Chinese character structure, the outside part of the turning line being a first recording part, the inside part of the turning line being an after recording part;

The table of Chinese character stroke order special situation comprises Chinese character structures which are processed according to the Chinese character stroke order quickly determining method but determined stroke orders are different from standard stroke orders set by a standard setter and basic Chinese character structures which are not processed according to the Chinese character stroke order quickly determining method.

The method can also include a split rule: “if a Chinese character structure contains a horizontal potential gap which can be run through, obtaining a horizontal line to run through the horizontal potential gap of the Chinese character structure, the above part of the horizontal line being a first recording part, the below part of the horizontal line being an after recording part;”, as a split rule E being included behind the split rule D, as a split rule C2 being included behind and next to the split rule C, as a split rule B2 being included behind and next to the split rule B, or as a split rule A2 being included behind and next to the split rule A.

The method can also include a split rule B3 replacing the split rule B. The split rule B3 is: if a Chinese character structure contains a horizontal gap or a horizontal potential gap which can be run through, obtaining a horizontal line to run through the horizontal gap or the horizontal potential gap of the Chinese character structure, the above part of the horizontal line being a first recording part, the below part of the horizontal line being an after recording part.

The method can also include a split rule C3 replacing the split rules C and D. The split rule C3 is: if a Chinese character structure contains a turning gap or a turning potential gap which can be run through, obtaining a turning line to run through the turning gap or the turning potential gap of the Chinese character structure, the outside part of the turning line being a first recording part, the inside part of the turning line being an after recording part.

The method can further include a split rule: “if a Chinese character structure contains a vertical potential gap which can be run through, obtaining a vertical line to run through the vertical potential gap of the Chinese character structure, the left part of the vertical line being a first recording part, the right part of the vertical line being an after recording part;”, as a split rule F being included behind the last split rule, as a split rule C4 being included before and next to the split rule D, or as a split rule B4 being included before and next to the split rule C.

The information recording apparatus referred to in the Chinese character information recording method can be a computer system which is equipped with a Chinese character input function and an input device.

Chinese characters have experienced thousands of years of changes. Situations are complex. In order to solve these complex situations, the following points make supplementary description for the Chinese character stroke order quickly determining method:

a. The horizontal lines referred to in the method comprise a slash “I” which resembles the Chinese character stroke “Lift”.

b. The turning lines referred to in the method mean that the turning lines have one and only one zigzag main body which turns around all or most of a part of a Chinese character structure; this part is “the inside part of the turning line”, and the other part of the Chinese character structure is “the outside part of the turning line”. Both the inside part and the outside part of the turning line are not empty. Do not obtain a turning line of which the zigzag main body is undistinguishable to split a Chinese character structure.

c. In a Chinese character structure, there are separation, connection, and intersection three kinds of relations between two strokes. We think: there is a gap between two separate strokes; there is a potential gap between two connective strokes, just as there is a potential gap between a chair and the ground, and just as there is a potential gap between an object which is attached to the wall and the wall. The “run through a . . . gap of a Chinese character structure” referred to in the method means that a split line (a vertical line, a horizontal line, or a turning line) which runs through a Chinese character structure does not cut off any one stroke, that the split line walks in a gap between two parts of a Chinese character structure from beginning to end, and that two ends of the split line can be forward extended without being blocked or connected to each other without being blocked. The “run through a . . . potential gap of a Chinese character structure” referred to in the method means that a split line (a vertical line, a horizontal line, or a turning line) which runs through a Chinese character structure does not cut off any one stroke, that the split line walks in a gap or a potential gap between two parts of a Chinese character structure from beginning to end, that two ends of the split line can be forward extended without being blocked or connected to each other without being blocked, and that the split line runs through at least one potential gap. The “does not cut off any one stroke” is a concept. In the concrete implementation, drawing a visible line with a certain width to run through a potential gap, the line must cover strokes on both sides of the potential gap; drawing a line to run through a small gap, the line also may cover strokes on both sides of the gap. At this time, do not consider that the strokes are cut off.

d. Gaps or potential gaps of Chinese character structures are not always straight; many are uneven. So the vertical lines, the horizontal lines, the vertical sections of the turning lines, and the horizontal sections of the turning lines referred to in the method, some are straight; some are curve; some are wavy. Do not deliberately turn the split lines when split.

e. In the outside part of the turning line, the stroke (strokes) completely below the inside part of the turning line is (are) recorded after the inside part of the turning line is recorded. If the outside part of the turning line contains the stroke (strokes) extending to the underside of the inside part of the turning line from the left side of the inside part of the turning line and there is (are) half or more than half a stroke (strokes) of the outside part of the turning line, namely half or more than half of the outside part of the turning line, below the inside part of the turning line, the outside part of the turning line is recorded after the inside part of the turning line is recorded; can take “one third or more than one third” to replace the “half or more than half”.

f. When obtain a split manner, a “Lift” and a “Hook” which are at the end of a stroke of a Chinese character structure can be ignored.

g. When obtain a vertical line or a horizontal line to split and there is more than one split manner, can obtain any one of them.

h. When obtain a turning line to split and there is more than one split manner, can skip this split rule and obtain another split manner in the follow-on split rules, or process as follows:

h1. A Chinese character structure contains a “ [symbol] ” group structure, and the “ [symbol] ” group structure divides the Chinese character structure out the left and the right two intervals; thus appears more than one split manner in which can obtain the turning line to split. Split the interval (intervals) which need to be split according to the order which reference signs without arrows display in FIG. 1, and record the Chinese character structure according to the order displayed in FIG. 1. It can be empty of strokes in the interval (intervals) which the “ [symbol] ” group structure divides out. Parts composing the “ [symbol] ” group structure are not always complete; some of them can be cut. So the “ [symbol] ” group structure can comprise a “ [symbol] ” type, a “ [symbol] ” type, a “ [symbol] ” type, etc.; the recording order of each type is correspondingly cut on the basis of the recording order of the “ [symbol] ” type. The upper part, the middle part, and the lower part of the “ [symbol] ” group structure which are connective represent a Chinese character structure, separately.

h2. A Chinese character structure contains a “beaded” structure, and the “beaded” structure divides the Chinese character structure out the upper-left, the upper-right, the lower-left, and the lower-right four intervals; thus appears more than one split manner in which can obtain the turning line to split. Split the interval (intervals) which need to be split according to the order which reference signs without arrows display in FIG. 2, and record the Chinese character structure according to the order displayed in FIG. 2. It can be empty of strokes in the interval (intervals) which the “beaded” structure divides out. The horizontal section and the vertical section of the “beaded” structure which are intersecting represent a Chinese character structure, separately.

h3. A Chinese character structure contains a “ [symbol] ” group structure, and the “ [symbol] ” group structure divides the Chinese character structure out a plurality of intervals; thus appears more than one split manner in which can obtain the turning line to split. Split the interval (intervals) which need to be split according to the order which reference signs without arrows display in FIG. 3, and record the Chinese character structure according to the order displayed in FIG. 3. It can be empty of strokes in the interval (intervals) which the “ [symbol] ” group structure divides out. Parts composing the “ [symbol] ” group structure are not always complete; some of them can be cut. So the “ [symbol] ” group structure can comprise a “ [symbol] ” type, a “ [symbol] ” type, a “ [symbol] ” type, a “ [symbol] ” type, a “ [symbol] ” type, a “ [symbol] ” type, a “ [symbol] ” type, etc.; the recording order of each type is correspondingly cut on the basis of the recording order of the “ [symbol] ” type. Parts composing the “ [symbol] ” group structure represent a Chinese character structure, separately.

h4. For other situations, split according to a manner in which the inside part of the turning line can obtain a maximum area.

h5. In the “ [symbol] ” group structure, the “beaded” structure, and the “ [symbol] ” group structure, each component and each interior of the interval divided out represents a Chinese character structure. Can separately list these Chinese character structures; continue to process them according to the Chinese character stroke order quickly determining method; and determine their recording orders (determine their recording orders of these Chinese character structures under the premise of following the total recording order of the “ [symbol] ” group structure or the “beaded” structure or the “ [symbol] ” group structure).

i. A Chinese character structure contains a plurality of separate subordinate Chinese character structures,

i1. In which some subordinate Chinese character structures are the same left and right or the same left and right around some Chinese character structure(s) else; these same subordinate Chinese character structures and the surrounded Chinese character structure(s) as a Chinese character structure group are kept integrally as far as possible to the last stage to split; can obtain another split manner or obtain a split manner in the follow-on split rules.

i2. In which some subordinate Chinese character structures are symmetrical left and right or symmetrical left and right around some Chinese character structure(s) else; these symmetrical subordinate Chinese character structures and the surrounded Chinese character structure(s) as a Chinese character structure group are kept integrally as far as possible to the last stage to split; can obtain another split manner or obtain a split manner in the follow-on split rules.

Split a Chinese character structure according to the Chinese character stroke order quickly determining method referred to in the Chinese character information recording method; mark out the vertical line(s), the horizontal line(s), and the turning line(s) which is (are) involved in the split process and the split order in the Chinese character structure; the formed Chinese character stroke order determining diagram device for teaching can intuitively display the Chinese character stroke order quickly determining method, and make the determining process of most Chinese character stroke orders easier.

The Chinese character stroke order determining diagram device for teaching can also be described as a method for preparing Chinese character stroke order determining diagram device for teaching. That is, split a Chinese character structure according to the Chinese character stroke order quickly determining method referred to in the Chinese character information recording method; mark out the vertical line(s), the horizontal line(s), and the turning line(s) which is (are) involved in the split process and the split order in the Chinese character structure.

Split a Chinese character structure according to other methods; mark out the split lines which are involved in the split process and the split order in the Chinese character structure; can also form the corresponding Chinese character stroke order determining diagram devices for teaching.

### SUMMARY OF THE INVENTION

### Advantageous Effects of Invention

Process the Chinese character structures according to the Chinese character stroke order quickly determining method; in determined stroke orders, a part is the same as standard stroke orders, and the other part is different from the standard stroke orders. Chinese character structures which are processed according to the Chinese character stroke order quickly determining method but determined stroke orders are different from the standard stroke orders and basic Chinese character structures which are not processed according to the Chinese character stroke order quickly determining method are included in the table of Chinese character stroke order special situation; this part of Chinese character structures are only a small amount; for instance, in the <Chinese Character Stroke Order Standard of GB13000.1 Character Set> which contains 20,902 Chinese characters and which is released on Oct. 1, 1999 by National Language Script Work Committee of Ministry of Education of China, it is only less than 400, compared with 20,902 Chinese characters, less than 2%.

Thus, split a Chinese character structure step by step into parts according to simple rules of the Chinese character stroke order quickly determining method and sequence these parts, and then can determine the rough stroke order of the Chinese character structure. By extension, can determine the rough stroke orders of most Chinese character structures; then determine the stroke orders of a few Chinese character structures included in the table of Chinese character stroke order special situation, and then can completely determine the stroke orders of most Chinese character structures. Combining the step for determining Chinese character strokes and the step for recording Chinese characters according to the Chinese character stroke orders by using an information recording apparatus, can realize to record most Chinese characters smoothly, for instance, the 20,902 Chinese characters. Compared with existing methods which takes 9 years to recognize the stroke orders of 7,000 commonly-used Chinese characters, the Chinese character information recording method may help Chinese character beginners who have no contact with Chinese characters, especially people outside of China learning Chinese, reduce the difficulty and shorten the time of realizing to record Chinese character information smoothly according to Chinese character stroke orders by using an information recording apparatus.

The Chinese character stroke order determining diagram device for teaching can intuitively display the Chinese character stroke order quickly determining method; thus further reduces the difficulty of the step for determining Chinese character stroke orders. So a solution in which the step for determining Chinese character stroke orders comprises the Chinese character stroke order quickly determining method, the table of Chinese character stroke order special situation, and the Chinese character stroke order determining diagram device for teaching may help Chinese character beginners further reduce the difficulty and shorten the time of realizing to record Chinese character information smoothly according to Chinese character stroke orders by using an information recording apparatus.

### BRIEF DESCRIPTION OF DRAWINGS

The present application will be further described below, by way of example, with reference to the accompanying drawings.

FIGS. 1, 2, 3, and 80 are recording order diagrams of the “ [symbol] ” type of the “ [symbol] ” group structure, the “ [symbol] ” type of the “beaded” structure, the “ [symbol] ” type of the “ [symbol] ” group structure, and a like “ [symbol] ” group structure, respectively.

FIG. 4 to FIG. 79 are displaying Figures of Chinese character structures which are displayed in corresponding Figures or Chinese character stroke order determining diagram devices for teaching of Chinese character structures which are displayed in corresponding Figures.

In FIGS. 1, 2, and 3, each reference sign with an arrow is a sign of a part of a type structure; each reference sign without an arrow is a sign of a Chinese character structure within an interval in which the reference sign is situated; the recording order of each type structure is consistent with the order of reference signs. In FIG. 4 to FIG. 79, “ [symbol] group”, “beaded”, “ [symbol] group”, and “special” are four short catchwords indispensable for understanding the present application; because FIG. 4 to FIG. 79 are images relating to Chinese characters and these four short catchwords are Chinese characters, in order to distinguish them from other parts in each Figure and save space, these four short catchwords are placed between parentheses.

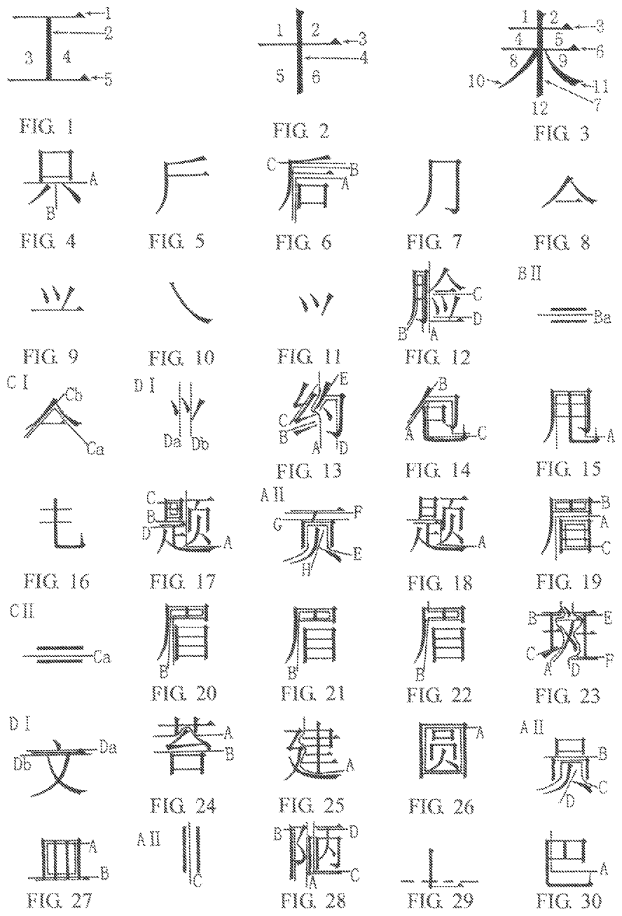

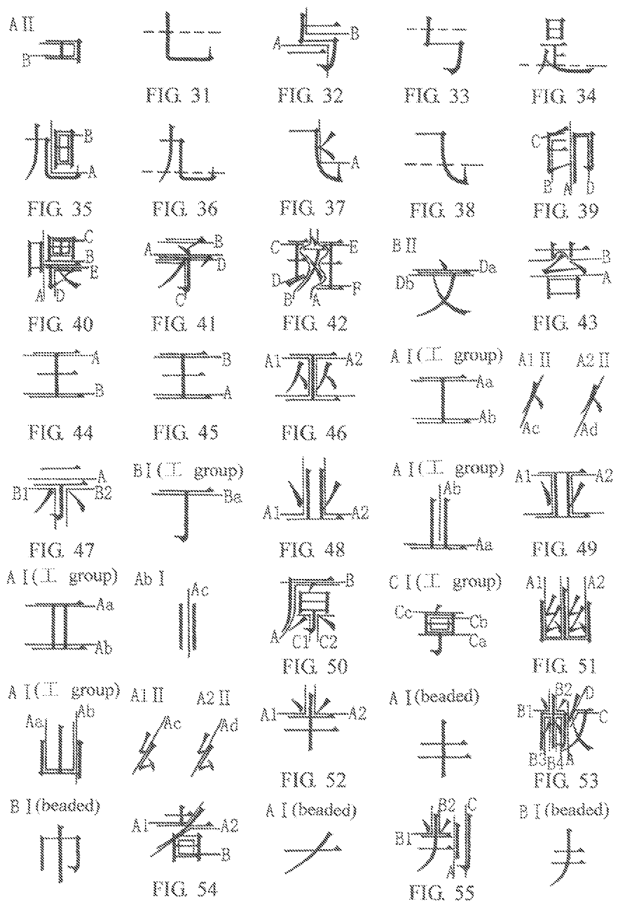

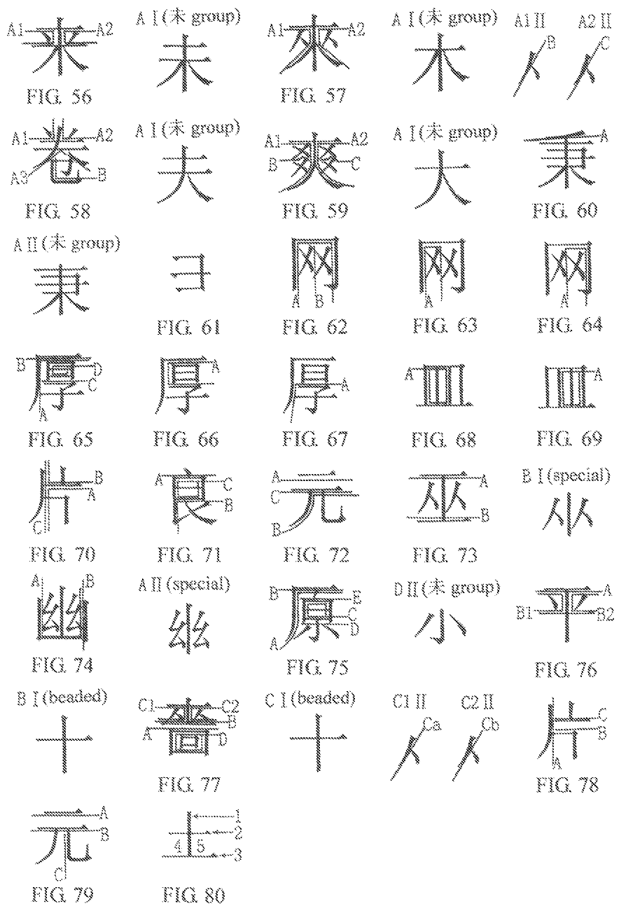

According to the characteristics of the Chinese character stroke order determining diagram device for teaching, in drawings, figure numbers of Chinese character stroke order determining diagram devices for teaching are marked below the front of every Figure. Thus, it appears such a situation: the Figure before a figure number belongs to the range of the Figure of the previous figure number. For example, the Figure before the figure number “FIG. 2” belongs to FIG. 1; the Figure before the figure number “FIG. 3” belongs to FIG. 2. Another example, the Figure before the figure number “FIG. 12” belongs to FIG. 11; the Figure before the figure number “FIG. 13” belongs to FIG. 12; so FIG. 12 includes four small diagrams. In FIG. 1 to FIG. 80, the number of small diagrams which each Figure includes is as follows (in order to describe simply, for instance, FIG. 12 includes four small diagrams, abbreviated as “FIG. 12-4”; FIG. 17 contains two small diagrams, abbreviated as “FIG. 17-2”.): FIG. 12-4, FIG. 17-2, FIG. 19-2, FIG. 23-2, FIG. 26-2, FIG. 27-2, FIG. 30-2, FIG. 42-2, FIG. 46-4, FIG. 47-2, FIG. 48-2, FIG. 49-3, FIG. 50-2, FIG. 51-4, FIG. 52-2, FIG. 53-2, FIG. 54-2, FIG. 55-2, FIG. 56-2, FIG. 57-4, FIG. 58-2, FIG. 59-2, FIG. 60-2, FIG. 73-2, FIG. 74-2, FIG. 75-2, FIG. 76-2, FIG. 77-4; every remaining Figure contains one small diagram.

### DETAILED DESCRIPTION

When obtain a split manner according to the Chinese character stroke order quickly determining method referred to in the present application, it is the best mode for the Chinese character information recording method and the Chinese character stroke order determining diagram device for teaching that accord to the order of split rule A, split rule B, split rule C, split rule D, split rule E, split rule F.

In the Chinese character information recording method, the first step (the step for determining Chinese character strokes) and the third step (the step for recording Chinese characters according to the Chinese character stroke orders by using an information recording apparatus) are the same as other existing methods. A mode for the characteristic step for determining Chinese character stroke orders and the Chinese character stroke order determining diagram device for teaching is described below.

In the mode, when obtain a split manner according to the Chinese character stroke order quickly determining method, accord to the order of split rule A, split rule B, split rule C, split rule D, split rule E, split rule F. According to other orders when obtain a split manner, except that the split order is different and that the Chinese character structures which the table of Chinese character stroke order special situation contains are different caused by the difference of the split order, other situations are the same. In order to illustrate simply, character form regulations and stroke order regulations of Chinese characters which are used to illustrate are both according to regulations of mainland China; Chinese characters under other sets of character form regulations and stroke order regulations can also be processed by the Chinese character information recording method. In order to describe concisely, “comparing a Chinese character structure with a split method from the first split rule of a sequence of split rules of the split method to the last split rule of the sequence of split rules of the split method, split rule one is the first suitable split rule of the sequence of split rules of the split method, so split the Chinese character structure according to this split rule.” is briefly described as “according to the split rule one” in the following description.

Example 1: determining the stroke order of “ [symbol] ”.

1. To split “ [symbol] ”. According to the split rule B, obtain a horizontal line to run through the horizontal gap of the “ [symbol] ”. The “ [symbol] ” above the horizontal line is a first recording part; the “ [symbol] ” below the horizontal line is an after recording part. The “ [symbol] ” is a basic Chinese character structure included in the table of Chinese character stroke order special situation; do not split it according to the method; then split the “ [symbol] ”.

2. To split “ [symbol] ”. According to the split rule A, obtain a vertical line to run through the vertical gap of the “ [symbol] ”. The “ [symbol] ” at the left of the vertical line is a first recording part; the “ [symbol] ” at the right of the vertical line is an after recording part. Both these two parts are single strokes; no more split them.

Thus, the rough stroke order of “ [symbol] ” is: [symbol] , [symbol] , [symbol] . As long as determine the stroke order of “ [symbol] ”, can completely determine the stroke order of “ [symbol] ”.

A Chinese character stroke order determining diagram device for teaching of “ [symbol] ” is displayed in FIG. 4. A and B are split order signs of “ [symbol] ” in the diagram device for teaching, rather than split “according to the split rule one”; the split order is consistent with the alphabetical order. From the Chinese character stroke order determining diagram device for teaching of “ [symbol] ” can know:

The first step is to split “ [symbol] ”. Obtain a horizontal line A to run through the horizontal gap of the “ [symbol] ”. The “ [symbol] ” above the horizontal line A is a first recording part; the “ [symbol] ” below the horizontal line A is an after recording part.

The second step is to split “ [symbol] ”. Obtain a vertical line B to run through the vertical gap of the “ [symbol] ”. The “ [symbol] ” at the left of the vertical line B is a first recording part; the “ [symbol] ” at the right of the vertical line B is an after recording part.

Thus, from the Chinese character stroke order determining diagram device for teaching of “ [symbol] ” can know that the rough stroke order of “ [symbol] ” is: [symbol] , [symbol] , [symbol] .

Example 2: determining the stroke order of “ [symbol] ”.

1. To split “ [symbol] ”. According to the split rule C, obtain a turning line to run through its turning gap. The outside part of the turning line displayed in FIG. 5 is a first recording part; the “ [symbol] ” of the inside part of the turning line is an after recording part. The “ [symbol] ” is a basic Chinese character structure included in the table of Chinese character stroke order special situation; do not split it according to the method; then split the Chinese character structure displayed in FIG. 5.

2. To split the Chinese character structure displayed in FIG. 5. According to the split rule D, obtain a turning line to run through its turning potential gap. The “ [symbol] ” of the outside part of the turning line is a first recording part; the “ [symbol] ” of the inside part of the turning line is an after recording part. The “ [symbol] ” is a single stroke; no more split it; then split the “ [symbol] ”.

3. To split “ [symbol] ”. According to the split rule E, obtain a horizontal line to run through its horizontal potential gap. The “ [symbol] ” above the horizontal line is a first recording part; the “ [symbol] ” below the horizontal line is an after recording part. Both these two parts are single strokes; no more split them.

Thus, the rough stroke order of “ [symbol] ” is: [symbol] , [symbol] , [symbol] , [symbol] . As long as determine the stroke order of the “ [symbol] ”, can completely determine the stroke order of “ [symbol] ”.

A Chinese character stroke order determining diagram device for teaching of “ [symbol] ” is displayed in FIG. 6; from it can know:

The first step is to split “ [symbol] ”. Obtain a turning line A to run through its turning gap. The outside part of the turning line A displayed in FIG. 5 is a first recording part; the “ [symbol] ” of the inside part of the turning line A is an after recording part.

The second step is to split the Chinese character structure displayed in FIG. 5. Obtain a turning line B to run through its turning potential gap. The “ [symbol] ” of the outside part of the turning line B is a first recording part; the “ [symbol] ” of the inside part of the turning line B is an after recording part.

The third step is to split “ [symbol] ”. Obtain a horizontal line C to run through its horizontal potential gap. The “ [symbol] ” above the horizontal line C is a first recording part; the “ [symbol] ” below the horizontal line C is an after recording part.

Thus, from the Chinese character stroke order determining diagram device for teaching of “ [symbol] ” can know that the rough stroke order of “ [symbol] ” is [symbol] , [symbol] , [symbol] , [symbol] .

Example 3: determining the stroke order of “ [symbol] ”.

1. To split “ [symbol] ”. According to the split rule A, obtain a vertical line to run through its vertical gap. The “ [symbol] ” at the left of the vertical line is a first recording part; the “ [symbol] ” at the right of the vertical line is an after recording part. Then split “ [symbol] ” and “ [symbol] ” respectively.

2. To split “ [symbol] ”. According to the split rule D, obtain a turning line to run through its turning potential gap. The outside part of the turning line displayed in FIG. 7 is a first recording part; the “ [symbol] ” of the inside part of the turning line is an after recording part. The Chinese character structure displayed in FIG. 7 is a basic Chinese character structure included in the table of Chinese character stroke order special situation; do not split it according to the method; then split the “ [symbol] ”.

3. To split “ [symbol] ”. According to the split rule B, obtain a horizontal line to run through its horizontal gap. The “ [symbol] ” above the horizontal line is a first recording part; the “ [symbol] ” below the horizontal line is an after recording part. Both these two parts are single strokes; no more split them.

4. To split “ [symbol] ”. According to the split rule B, obtain a horizontal line to run through its horizontal gap. The part above the horizontal line displayed in FIG. 8 is a first recording part; the part below the horizontal line displayed in FIG. 9 is an after recording part. Then split these two parts respectively.

5. To split the Chinese character structure displayed in FIG. 8. According to the split rule C, obtain a turning line to run through its turning gap. The “ [symbol] ” of the outside part of the turning line is a first recording part; the “ [symbol] ” of the inside part of the turning line is an after recording part. The “ [symbol] ” is a single stroke; no more split it; then split the “ [symbol] ”.

6. To split “ [symbol] ”. According to the split rule E, obtain a horizontal line to run through its horizontal potential gap. The “ [symbol] ” above the horizontal line is a first recording part; the part below the horizontal line displayed in FIG. 10 is an after recording part. Both these two parts are single strokes; no more split them.

7. To split the Chinese character structure displayed in FIG. 9. According to the split rule B, obtain a horizontal line to run through its horizontal gap. The part above the horizontal line displayed in FIG. 11 is a first recording part; the “ [symbol] ” below the horizontal line is an after recording part. The “ [symbol] ” is a single stroke; no more split it; then split the Chinese character structure displayed in FIG. 11.

8. To split the Chinese character structure displayed in FIG. 11. According to the split rule A, obtain a vertical line to run through its vertical gap. The “ [symbol] ” at the left of the vertical line is a first recording part; the “ [symbol] ” at the right of the vertical line is an after recording part. The “ [symbol] ” is a single stroke; no more split it; then split the “ [symbol] ”

[symbol]

9. To split “ [symbol] ”. According to the split rule A, obtain a vertical line to run through its vertical gap. The “ [symbol] ” at the left of the vertical line is a first recording part; the “ [symbol] ” at the right of the vertical line is an after recording part. Both these two parts are single strokes; no more split them.

Thus, the rough stroke order of “ [symbol] ” is: “the Chinese character structure displayed in FIG. 7”, [symbol] , [symbol] , [symbol] , “the Chinese character structure displayed in FIG. 10”, [symbol] , [symbol] , [symbol] , [symbol] , [symbol] . As long as determine the stroke order of the Chinese character structure displayed in FIG. 7, can completely determine the stroke order of “ [symbol] ”.

A Chinese character stroke order determining diagram device for teaching of “ [symbol] ” is displayed in FIG. 12. A, B, Ba, C, Ca, Cb, D, Da, and Db are split order signs of “ [symbol] ” in the diagram device for teaching, rather than split “according to the split rule one”; the split order is consistent with the alphabetical order. Rome numeral “I” indicates first recording parts, comprising the parts at the left of the vertical line, above the horizontal line, and outside of the turning line; “II” indicates after recording parts, comprising the parts at the right of the vertical line, below the horizontal line, and inside of the turning line; for instance, B II indicates the after recording part which is obtained after the split of step B; C I indicates the first recording part which is obtained after the split of step C; D I indicates the first recording part which is obtained after the split of step D. Thus, from the Chinese character stroke order determining diagram device for teaching FIG. 12 of “ [symbol] ” can know:

The first step is to split “ [symbol] ”. Obtain a vertical line A to run through its vertical gap. The “ [symbol] ” at the left of the vertical line A is a first recording part; the “ [symbol] ” at the right of the vertical line A is an after recording part.

The second step is to split “ [symbol] ”. Obtain a turning line B to run through its turning potential gap. The outside part of the turning line B displayed in FIG. 7 is a first recording part; the “ [symbol] ” of the inside part of the turning line B is an after recording part; in order to facilitate the following split, separately list the “ [symbol] ”, and mark by B II.

The third step is to split “ [symbol] ”. Obtain a horizontal line Ba to run through its horizontal gap. The “ [symbol] ” above the horizontal line Ba is a first recording part; the “ [symbol] ” below the horizontal line Ba is an after recording part.

The fourth step is to split “ [symbol] ”. Obtain a horizontal line C to run through its horizontal gap. The part above the horizontal line C displayed in FIG. 8 is a first recording part; separately list it and mark by C I; the part below the horizontal line C displayed in FIG. 9 is an after recording part.

The fifth step is to split the Chinese character structure displayed in C I. Obtain a turning line Ca to run through its turning gap. The “ [symbol] ” of the outside part of the turning line Ca is a first recording part; the “ [symbol] ” of the inside part of the turning line is an after recording part.

The sixth step is to split “ [symbol] ”. Obtain a horizontal line Cb to run through its horizontal potential gap. The “ [symbol] ” above the horizontal line Cb is a first recording part; the part below the horizontal line displayed in FIG. 10 is an after recording part.

The seventh step is to split the Chinese character structure displayed in FIG. 9. Obtain a horizontal line D to run through its horizontal gap. The part above the horizontal line D displayed in FIG. 11 is a first recording part; separately list it and mark by D I; the “ [symbol] ” below the horizontal line is an after recording part.

The eighth step is to split the Chinese character structure displayed in D I. Obtain a vertical line Da to run through its vertical gap. The “ [symbol] ” at the left of the vertical line Da is a first recording part; the “ [symbol] ” at the right of the vertical line is an after recording part.

The ninth step is to split “ [symbol] ”. Obtain a vertical line Db to run through its vertical gap. The “ [symbol] ” at the left of the vertical line Db is a first recording part; the “ [symbol] ” at the right of the vertical line Db is an after recording part.

Thus from the Chinese character stroke order determining diagram device for teaching of “ [symbol] ” can know that the rough stroke order of “ [symbol] ” is: “FIG. 7”, [symbol] , [symbol] , [symbol] , “FIG. 10”, [symbol] , [symbol] , [symbol] , [symbol] ,

[symbol]

Because there are different sets of character from regulations of Chinese characters and you can more easily understand the Chinese character stroke order quickly determining method by starting from simple examples, the “ [symbol] ” is included in the table of Chinese character stroke order special situation in examples 1 and 2. In fact, according to different sets of character from regulations, the “ [symbol] ” can also be split into “ [symbol] ” and “ [symbol] ” according to the split rule D or according to the split rule E.

Make further explanation for the part of supplementary description of the Chinese character stroke order quickly determining method below.

Example 4: a Chinese character stroke order determining diagram device for teaching of “ [symbol] ” is displayed in FIG. 13. Step B is to obtain the “/” which is comprised in the horizontal lines to run through the horizontal gap. Steps C and E are to obtain the “/” which is comprised in the horizontal lines to run through the horizontal potential gaps.

Example 5: a Chinese character stroke order determining diagram device for teaching of “ [symbol] ” is displayed in FIG. 14. Step A is to obtain a turning line A to run through the turning gap of “ [symbol] ”. The left part of the turning line A is the zigzag main body; it zigzags around most of “ [symbol] ”; thus “ [symbol] ” is the inside part of the turning line.

Example 6: a Chinese character stroke order determining diagram device for teaching of “ [symbol] ” is displayed in FIG. 15. Step A is to obtain a turning line A to run through the turning potential gap of “ [symbol] ”. The left part of the turning line A is the zigzag main body; it zigzags around most of the Chinese character structure displayed in FIG. 16; thus the Chinese character structure displayed in FIG. 16 is the inside part of the turning line.

Example 7: a Chinese character stroke order determining diagram device for teaching of “ [symbol] ” is displayed in FIG. 17. Step A is to obtain a turning line A to run through the turning gap of “ [symbol] ”. Because the zigzag main body is undistinguishable, do not obtain a turning line A displayed in FIG. 18 to split “ [symbol] ”.

Example 8: a Chinese character stroke order determining diagram device for teaching of “ [symbol] ” is displayed in FIG. 19. Step B is to obtain a turning line B to run through the turning potential gap of “ [symbol] ”. In the Chinese character stroke order determining diagram device for teaching, sometimes in order for clear indication, add a short line as an indication between the split line and the split order sign, as shown by the turning line B in FIG. 19. Because two ends of the turning line are directly adjacent and do not walk in the gap or potential gap between two parts of the Chinese character structure from beginning to end, do not obtain the turning line B to split as shown in FIG. 20. Because one end of the turning line cannot be forward extended without being blocked or cannot be connected with the other end without being blocked, do not obtain the turning line B to split as shown in FIG. 21. Because the zigzag main body is undistinguishable, do not obtain the turning line B to split as shown in FIG. 22.

The “from beginning to end” referred to in the point c means that the split line cannot run through between two parts with the middle of the split line, but two ends of the split line are directly adjacent, as shown in FIG. 20; that the Chinese character structures on both sides of the split line are not required closing from beginning to end (for instance, the Chinese character structure on the underside of the horizontal line D is completely closing, but the Chinese character structure on the upside has open gaps, as shown in FIG. 12; it is allowed.); and that the split line as far as possible runs through in the gap or potential gap, but if it is inevitable, the ends of the split line are not required that there are Chinese character structures covering at the same time from beginning to end on both sides (for instance, there is a Chinese character structure covering with wide range on the upside of horizontal line F, but there is a Chinese character structure covering only on the middle part of the underside; there is no Chinese character structure covering at two ends on the underside, as shown in FIG. 17; it is allowed.).

Example 9: a Chinese character stroke order determining diagram device for teaching of “ [symbol] ” is displayed in FIG. 23. Steps A and D are to obtain wavy vertical lines to run through the vertical gaps. In order not to deliberately zigzag the split line, step Da is to obtain a horizontal line rather than a turning line; another example, in FIG. 17, steps F and G are to obtain horizontal lines rather than turning lines.

Example 10: a Chinese character stroke order determining diagram device for teaching of “ [symbol] ” is displayed in FIG. 24. Step A is to obtain a wavy horizontal line to run through the horizontal gap.

Example 11: a Chinese character stroke order determining diagram device for teaching of “ [symbol] ” is displayed in FIG. 25. Step A is to obtain a turning line whose vertical section presents wave to run through the turning gap.

Example 12: a Chinese character stroke order determining diagram device for teaching of “ [symbol] ” is displayed in FIG. 26. Step A is to obtain a turning line A to run through the turning gap of “ [symbol] ”. The “ [symbol] ” of the outside part of the turning line A is a first recording part; the “ [symbol] ” of the inside part is an after recording part. The “ [symbol] ” at the bottom of the “ [symbol] ” is completely below the “ [symbol] ”; thus this “ [symbol] ” is recorded after the “ [symbol] ” is recorded. The recording order of “ [symbol] ” is: [symbol] , [symbol] , [symbol] .

Example 13: a Chinese character stroke order determining diagram device for teaching of “ [symbol] ” is displayed in FIG. 27. The “ [symbol] ” at the bottom of part A I is completely below part A II; thus this “ [symbol] ” is recorded after part A II is recorded. The recording order of “ [symbol] ” is: [symbol] , [symbol] , [symbol] .

Example 14: a Chinese character stroke order determining diagram device for teaching of “ [symbol] ” is displayed in FIG. 28. Part C I contains the stroke which extends to the underside of part C II from the left side, and there is half a stroke below part C II, as shown by the part below the dotted line in FIG. 29; thus the C I part is recorded after part C II is recorded.

Example 15: a Chinese character stroke order determining diagram device for teaching of “ [symbol] ” is displayed in FIG. 30. Part A I contains the stroke which extends to the underside of part A II from the left side, and there is more than half a stroke below part A II, as shown by the part below the dotted line in FIG. 31; thus part A I is recorded after part A II is recorded.

Example 16: a Chinese character stroke order determining diagram device for teaching of “ [symbol] ” is displayed in FIG. 32. Part B I contains the stroke which extends to the underside of part B II from the left side, and there is more than half a stroke below part B II, as shown by the part below the dotted line in FIG. 33; thus part B I is recorded after part B II is recorded.

Example 17: a Chinese character stroke order determining diagram device for teaching of “ [symbol] ” is displayed in FIG. 17. Part A I contains the strokes which extend to the underside of part A II from the left side, but there are only less than half strokes below part A II, as shown by the part below the dotted line in FIG. 34; thus all of part A I, including the strokes which extend to the underside of part A II from the left side, is recorded before part A II is recorded.

Example 18: a Chinese character stroke order determining diagram device for teaching of “ [symbol] ” is displayed in FIG. 35. Part A I contains the strokes which extend to the underside of part A II from the left side, but there are only less than half strokes below part A II, as shown by the part below the dotted line in FIG. 36; thus all of part A I, including the strokes which extend to the underside of part A II from the left side, is recorded before part A II is recorded.

Example 19: a Chinese character stroke order determining diagram device for teaching of “ [symbol] ” is displayed in FIG. 37. Part A I contains the stroke which extends to the underside of part A II from the left side, but there is only less than half a stroke below part A II, as shown by the part below the dotted line in FIG. 38; thus part A I is recorded before part A II is recorded.

First half sentence of the second sentence in the point e can be further defined as: “If the outside part of the turning line contains the stroke (strokes) extending to the underside of the inside part of the turning line from the left side of the inside part of the turning line and there is (are) half or more than half a stroke (strokes) of the outside part of the turning line (after the stroke (strokes) which is (are) contained in the outside part of the turning line and which is (are) completely above the inside part of the turning line is (are) removed), namely half or more than half of the outside part of the turning line (after the stroke (strokes) which is (are) contained in the outside part of the turning line and which is (are) completely above the inside part of the turning line is (are) removed), below the inside part of the turning line, the outside part of the turning line (after the stroke (strokes) which is (are) contained in the outside part of the turning line and which is (are) completely above the inside part of the turning line is (are) removed) is recorded after the inside part of the turning line is recorded;”. For example, the stroke “ [symbol] ” of “ [symbol] ” is recorded after the “ [symbol] ” of the inside part of the turning line is recorded; because the other parts of the outside part of the turning line are completely above the “ [symbol] ” of the inside part of the turning line, they are still first recorded following “the outside part of the turning line is a first recording part”.

Example 20: a Chinese character stroke order determining diagram device for teaching of “ [symbol] ” is displayed in FIG. 39. When step B splits, ignore the “Lift” at the end of the stroke “ [symbol] ” in part B I.

Example 21: a Chinese character stroke order determining diagram device for teaching of “ [symbol] ” is displayed in FIG. 40. When step D splits, ignore the “Lift” at the end of the stroke “ [symbol] ” in the D I part.

Example 22: a Chinese character stroke order determining diagram device for teaching of “ [symbol] ” is displayed in FIG. 41. When steps B, C, and D split, ignore the “Hooks” at the end of the strokes.

Example 23: Chinese character stroke order determining diagram devices for teaching of “ [symbol] ” as shown in FIG. 23 and FIG. 42 are both correct. The first step is to obtain a vertical line A to run through the vertical gap of “ [symbol] ”. There are two manners to run through; can obtain any one; that is, can obtain the manner as shown in FIG. 23 or FIG. 42.

Example 24: Chinese character stroke order determining diagram devices for teaching of “ [symbol] ” as shown in FIG. 24 and FIG. 43 are both correct. The first step is to obtain a horizontal line A to run through the horizontal gap of “ [symbol] ”. There are two manners to run through; can obtain any one; that is, can obtain the manner as shown in FIG. 24 or FIG. 43.

Example 25: Chinese character stroke order determining diagram devices for teaching of “ [symbol] ” as shown in FIG. 44 and FIG. 45 are both correct. The first step is to obtain a horizontal line A to run through the horizontal potential gap of “ [symbol] ”. There are two manners to run through; can obtain any one; that is, can obtain the manner as shown in FIG. 44 or FIG. 45.

Example 26: a Chinese character stroke order determining diagram device for teaching of “ [symbol] ” is displayed in FIG. 46. The first step is to obtain a turning line to run through the turning gap of “ [symbol] ”. There are two manners to run through; after running through these two turning gaps, a “ [symbol] ” group structure will be left over. Thus obtain turning lines A1 and A2 to respectively run through two turning gaps in the same step A, and line A1 precedes line A2. A I is the first recording part which is obtained after the step A splits; A1 II and A2 II respectively indicate the after recording parts which are obtained after obtaining the turning lines A1 and A2 to split. Part A I of this example is a “ [symbol] ” type of the “ [symbol] ” group structure. Parts A1 II and A2 II are respectively continued to split according to the point h5. Referencing the recording order of the “ [symbol] ” group structure, the stroke order of “ [symbol] ” is: [symbol] , [symbol] , [symbol] , [symbol] , [symbol] , [symbol] , [symbol] .

Example 27: a Chinese character stroke order determining diagram device for teaching of “ [symbol] ” is displayed in FIG. 47. Part B I is a “ [symbol] ” type of the “ [symbol] ” group structure; its middle part is the Chinese character structure “ [symbol] ”. Referencing the recording order of the “ [symbol] ” group structure, the stroke order of “ [symbol] ” is: [symbol] , [symbol] , [symbol] , [symbol] , [symbol] .

Example 28: a Chinese character stroke order determining diagram device for teaching of “ [symbol] ” is displayed in FIG. 48. Part A I is a “ [symbol] ” type of the “ [symbol] ” group structure; its middle part is the Chinese character structure “ [symbol] ”. Part Aa I is continued to split according to the point h5. Referencing the recording order of the “ [symbol] ” group structure, the stroke order of “ [symbol] ” is: [symbol] , [symbol] , [symbol] , [symbol] , [symbol] .

Example 29: a Chinese character stroke order determining diagram device for teaching of “ [symbol] ” is displayed in FIG. 49. Part A I is a “ [symbol] ” type of the “ [symbol] ” group structure; its middle part is the Chinese character structure “ [symbol] ”. Part Ab I is continued to split according to the point h5. Referencing the recording order of the “ [symbol] ” group structure, the stroke order of “ [symbol] ” is: [symbol] , [symbol] , [symbol] , [symbol] , [symbol] , [symbol] .

Example 30: a Chinese character stroke order determining diagram device for teaching of “ [symbol] ” is displayed in FIG. 50. Part C I is a “ [symbol] ” type of the “ [symbol] ” group structure; its upper part is the Chinese character structure “ [symbol] ”; its middle part is the Chinese character structure “ [symbol] ”. Part C I is continued to split according to the point h5. Referencing the recording order of the “ [symbol] ” group structure, the rough stroke order of “ [symbol] ” is: [symbol] , [symbol] , [symbol] , [symbol] , [symbol] , [symbol] , [symbol] , [symbol] , [symbol] .

Example 31: a Chinese character stroke order determining diagram device for teaching of “ [symbol] ” is displayed in FIG. 51. Part A I is a “ [symbol] ” type of the “ [symbol] ” group structure; its lower part is the Chinese character structure “ [symbol] ”. Parts A1 II and A2 II are respectively continued to split according to the point h5. Referencing the recording order of the “ [symbol] ” group structure, the rough stroke order of “ [symbol] ” is: [symbol] , [symbol] , [symbol] , [symbol] , [symbol] , [symbol] , [symbol] .

Example 32: a Chinese character stroke order determining diagram device for teaching of “ [symbol] ” is displayed in FIG. 52. After obtaining turning lines A1 and A2 to respectively run through two turning gaps in the same step A, part A I is a “beaded” structure. It is empty of strokes in its lower-left and its lower-right two intervals. Its horizontal part is the Chinese character structure “ [symbol] ”; its vertical part is the Chinese character structure “ [symbol] ”. Referencing the recording order of the “beaded” structure, the rough stroke order of “ [symbol] ” is: [symbol] , [symbol] , [symbol] , [symbol] .

Example 33: a Chinese character stroke order determining diagram device for teaching of “ [symbol] ” is displayed in FIG. 53. Obtain turning lines B1, B2, B3, and B4 to respectively run through four turning gaps in the same step B, and the order is B1, B2, B3, B4. The obtained first recording part B I is a “beaded” structure. Its horizontal part is the Chinese character structure “ [symbol] ”; its vertical part is the Chinese character structure “ [symbol] ”. Referencing the recording order of the “beaded” structure, the rough stroke order of “ [symbol] ” is: [symbol] , [symbol] , [symbol] , [symbol] , [symbol] , [symbol] , [symbol] , [symbol] , [symbol] .

Example 34: a Chinese character stroke order determining diagram device for teaching of “ [symbol] ” is displayed in FIG. 54. Part A I is a “beaded” structure. It is empty of strokes in its upper-right and its lower-left two intervals. Its horizontal part is “ [symbol] ”; its vertical part is “ [symbol] ”. Referencing the recording order of the “beaded” structure, the rough stroke order of “ [symbol] ” is: [symbol] , [symbol] , [symbol] , [symbol] , [symbol] , [symbol] .

Example 35: a Chinese character stroke order determining diagram device for teaching of “ [symbol] ” is displayed in FIG. 55. Part B I is a “beaded” structure. It is empty of strokes in its lower-left and its lower-right two intervals. Its horizontal part is “ [symbol] ”; its vertical part is “ [symbol] ”. Referencing the recording order of the “beaded” structure, the rough stroke order of “ [symbol] ” is: [symbol] , [symbol] , [symbol] , [symbol] , [symbol] , [symbol] .

Example 36: a Chinese character stroke order determining diagram device for teaching of “ [symbol] ” is displayed in FIG. 56. After obtaining turning lines A1 and A2 to respectively run through two turning gaps in the same step A, part A I is a “ [symbol] ” group structure. It is empty of strokes in a plurality of intervals which the “ [symbol] ” group structure divides out. Referencing the recording order of the “ [symbol] ” group structure, the stroke order of “ [symbol] ” is: [symbol] , [symbol] , [symbol] , [symbol] , [symbol] , [symbol] , “FIG. 10”.

Example 37: a Chinese character stroke order determining diagram device for teaching of “ [symbol] ” is displayed in FIG. 57. Part A I is a “ [symbol] ” group structure which is cut. It is empty of strokes in a plurality of intervals which the “ [symbol] ” group structure divides out. Referencing the recording order of the “ [symbol] ” group structure, the stroke order of “ [symbol] ” is: [symbol] , [symbol] , [symbol] , [symbol] , [symbol] , [symbol] , [symbol] , “FIG. 10”.

Example 38: a Chinese character stroke order determining diagram device for teaching of “ [symbol] ” is displayed in FIG. 58. Part A I is a “ [symbol] ” group structure which is cut. It is empty of strokes in a plurality of intervals which the “ [symbol] ” group structure divides out. Referencing the recording order of the “ [symbol] ” group structure, the rough stroke order of “ [symbol] ” is: [symbol] , [symbol] , [symbol] , [symbol] , [symbol] , “FIG. 10”, “ [symbol] ”.

Example 39: a Chinese character stroke order determining diagram device for teaching of “ [symbol] ” is displayed in FIG. 59. Part A I is a “ [symbol] ” group structure which is cut. It is empty of strokes in a plurality of intervals which the “ [symbol] ” group structure divides out. Referencing the recording order of the “ [symbol] ” group structure, the rough stroke order of “ [symbol] ” is: [symbol] , [symbol] , [symbol] , [symbol] , [symbol] , [symbol] , “FIG. 10”.

Example 40: a Chinese character stroke order determining diagram device for teaching of “ [symbol] ” is displayed in FIG. 60. Part A II is a “ [symbol] ” group structure. One of its components (the part which 6 indicates in FIG. 3) is the Chinese character structure displayed in FIG. 61.

Example 41: a Chinese character stroke order determining diagram device for teaching of “ [symbol] ” is displayed in FIG. 62. Step A is to obtain a turning line A to run through the turning gap. Because there is more than one split manner, and does not contain a “ [symbol] ” group or a “beaded” or a “ [symbol] ” group structure, according to the point h4, split according to a manner in which the inside part of the turning line can obtain a maximum area. Because the inside part of the turning line cannot obtain a maximum area, do not obtain the manner displayed in FIG. 63 or FIG. 64 to split.

Example 42: a Chinese character stroke order determining diagram device for teaching of “ [symbol] ” is displayed in FIG. 65. Step A is, according to the point h4, to split according to a manner in which the inside part of the turning line can obtain a maximum area. Because the inside part of the turning line cannot obtain a maximum area, do not obtain the manner displayed in FIG. 66 or FIG. 67 to split.

Example 43: a Chinese character stroke order determining diagram device for teaching of “ [symbol] ” is displayed in FIG. 27. Step A is, according to the point h4, to split according to a manner in which the inside part of the turning line can obtain a maximum area. Because the inside part of the turning line cannot obtain a maximum area, do not obtain the manner displayed in FIG. 68 or FIG. 69 to split.

Example 44: a Chinese character stroke order determining diagram device for teaching of “ [symbol] ” is displayed in FIG. 70. Step A is, according to the point h4, to split according to a manner in which the inside part of the turning line can obtain a maximum area.

Example 45: a Chinese character stroke order determining diagram device for teaching of “ [symbol] ” is displayed in FIG. 71. Step B is, according to the point h4, to split according to a manner in which the inside part of the turning line can obtain a maximum area.

Example 46: a Chinese character stroke order determining diagram device for teaching of “ [symbol] ” is displayed in FIG. 72. Step B is, according to the point h4, to split according to a manner in which the inside part of the turning line can obtain a maximum area.

Example 47: a Chinese character stroke order determining diagram device for teaching of “ [symbol] ” displayed in FIG. 73 is also correct. The first step should split according to the split rule C. But there are two split manners, so skip the split rule C, and obtain another split manner in the follow-on split rules. Thus obtain a horizontal line A to run through a horizontal potential gap of “ [symbol] ”. The second step should split according to the split rule C. But there are two split manners, so skip the split rule C, and obtain another split manner in the follow-on split rules. Thus obtain a horizontal line B to run through the horizontal potential gap of part A II. Part B I belongs to the Chinese character stroke order special situation.

Example 48: a Chinese character stroke order determining diagram device for teaching of “ [symbol] ” displayed in FIG. 74 is also correct. Step A is the split manner which is obtained after skipping “according to the split rule C”. Part A II is a Chinese character stroke order special situation.

Example 49: a Chinese character stroke order determining diagram device for teaching of “ [symbol] ” displayed in FIG. 75 is also correct. Step C is the split manner which is obtained after skipping “according to the split rule C”. Step D is the split manner which is obtained after skipping “according to the split rule C” again. The D II part is a “ [symbol] ” group structure.

Example 50: a Chinese character stroke order determining diagram device for teaching of “ [symbol] ” is displayed in FIG. 76. Step A is the split manner which is obtained after skipping “according to the split rule C”. Part B I is a “beaded” structure.

Example 51: a Chinese character stroke order determining diagram device for teaching of “ [symbol] ” is displayed in FIG. 77. Step B is the split manner which is obtained after skipping “according to the split rule C”. Part C I is a “beaded” structure.

Example 52: a Chinese character stroke order determining diagram device for teaching of “ [symbol] ” is displayed in FIG. 60. Step A is the split manner which is obtained after skipping “according to the split rule D”. Part A II is a “ [symbol] ” group structure.

Example 53: a Chinese character stroke order determining diagram device for teaching of “ [symbol] ” displayed in FIG. 78 is also correct. Step A is the split manner which is obtained after skipping “according to the split rule D”.

Example 54: a Chinese character stroke order determining diagram device for teaching of “ [symbol] ” displayed in FIG. 79 is also correct. Step B is the split manner which is obtained after skipping “according to the split rule D”.

It is a simple method that determine Chinese character stroke orders according to the “ [symbol] ” group structure, the “beaded” structure, and the “ [symbol] ” group structure. You can give priority to process around them if a Chinese character structure contains these structures. That is, in a split process, these structures and the Chinese character structures in the intervals which these structures divide out as a whole (a Chinese character structure group) are kept; process according to the points h1, h2, h3, and h5, and determine the stroke orders. It will form such a structure, if skip one split rule and obtain another split manner; then give priority to such a skip, for instance, example 50.

The “ [symbol] ” group structure, the “beaded” structure, and the “ [symbol] ” group structure respectively contain the characteristics which the points h1, h2, and h3 describe; each component of them represents a Chinese character structure, separately, so “ [symbol] , [symbol] ”, “ [symbol] , [symbol] ”, “ [symbol] , [symbol] ”, etc., also respectively contain “ [symbol] ” group structures, “beaded” structures, “ [symbol] ” group structures. The top of the vertical part of the “beaded” structure need not always completely run through the horizontal part, so “ [symbol] , [symbol] , [symbol] ”, etc., also contain “beaded” structures, separately. The two parts which 10 and 11 indicate in FIG. 3 can be separated, connective, or intersecting, so “ [symbol] , [symbol] , [symbol] ”, etc., also contain “ [symbol] ” group structures, separately. Because of the difference of sets of character form regulations, in Chinese characters of Japanese (Japanese characters), appears such Chinese character structures: strokes “Right Slope” (displayed in FIG. 10) of Chinese character structures “ [symbol] , [symbol] ” and the stroke “Right Slope” of the upper part of “ [symbol] ” separately intersect with the strokes “ [symbol] ” above the strokes “Right Slope”; these Chinese character structures conform to the characteristics which the point h3 describes, so still belong to the “ [symbol] ” group structure. There is partial overlap between the “ [symbol] ” group structure and the “ [symbol] ” group structure; there is partial overlap between the “beaded” structure and the “ [symbol] ” group structure. That is, some Chinese character structures can be considered as containing the “ [symbol] ” group structure, and can also be considered as containing the “ [symbol] ” group structure; some Chinese character structures can be considered as containing the “beaded” structure, and can also be considered as containing the “ [symbol] ” group structure. Meeting the overlap situation, can obtain any one. For instance, “ [symbol] ” can be considered as containing the “beaded” structure, and can also be considered as containing the “ [symbol] ” group structure.

The “ [symbol] ” group structure can be replaced by a “ [symbol] ” (simplified Chinese character) group structure. After being replaced, 4 and 5 in FIG. 3 will be added arrows, respectively indicating the “ [symbol] ” and the “ [symbol] ”, and become components of the “ [symbol] ” group structure; other characteristics, the “ [symbol] ” group structure and the “ [symbol] ” group structure are the same. The “ [symbol] ” group structure can also be replaced by a “ [symbol] ” group structure. After being replaced, 4, 5, and 6 in FIG. 3 are canceled; other characteristics, the “ [symbol] ” group structure and the “ [symbol] ” group structure are the same.

Example 55: when split “ [symbol] ”, the first step should split according to the split rule A, but according to the point i1, in order to obtain the subordinate Chinese character structure group “ [symbol] ” which is the same left and right as far as possible to be kept to the last stage to split, obtain a split manner in the follow-on split rules. Thus obtain a horizontal line to run through the horizontal gap of “ [symbol] ”; above the horizontal line is “ [symbol] ”, and below the horizontal line is “ [symbol] ”.

Example 56: when split “ [symbol] ”, the first step should split according to the split rule A, but according to the point i2, in order to obtain the subordinate Chinese character structure group “ [symbol] ” which is symmetrical left and right as far as possible to be kept to the last stage to split, obtain a split manner in the follow-on split rules. Thus obtain a turning line to run through the turning gap of “ [symbol] ”; the outside part of turning line is “ [symbol] ”, and the inside part of turning line is “ [symbol] ”.

The same Chinese character structure groups referred to in the point i1 comprise “ [symbol] , [symbol] , [symbol] , [symbol] ”, etc. The symmetrical Chinese character structure groups referred to in the point i2 comprise “ [symbol] , [symbol] , [symbol] , [symbol] ”, etc. The Chinese character structure groups which are kept and which are referred to in the point i1 and the point i2 are separate from other Chinese character structure(s), and as far as possible contain more said same or symmetrical subordinate Chinese character structure(s); for instance, to keep “ [symbol] ” of “ [symbol] ” rather than just to keep “ [symbol] ”

[symbol]

If needed, can take “a higher position part being a first recording part; if the position is level, then the outside part of the turning line being a first recording part” to replace the “the outside part of the turning line being a first recording part, the inside part of the turning line being an after recording part” in the split rules C, D, and C3.

From examples above, can determine the rough stroke orders of corresponding Chinese characters; then determine the stroke orders of Chinese character structures included in the table of Chinese character stroke order special situation; and then can completely determine the stroke orders of corresponding Chinese characters. Corresponding to different tables of Chinese character sets, for example, the <Table of Current Chinese Frequently-used Chinese Character> which contains 3,500 Chinese characters, the <Table of Current Chinese Commonly-used Chinese Character> which contains 7,000 Chinese characters, there are different tables of Chinese character stroke order special situation. Corresponding to different sets of Chinese character stroke order regulations, for example, Chinese character stroke order regulations of mainland China, Chinese character stroke order regulations of Hong Kong, Macao, or Taiwan, Chinese character stroke order regulations of Japan, there are also different tables of Chinese character stroke order special situation.

Can set up rules for the table of Chinese character stroke order special situation; thus reduce the number of Chinese character structures which the table contains. For example, some Chinese character structures are after recording: 1. A Chinese character structure contains a “Oblique Hook” group structure (comprising the Chinese character structure of the rest of “ [symbol] ” which is removed the stroke “ [symbol] ”; the Chinese character structure of the rest of “ [symbol] ” which is removed strokes “ [symbol] ” and “ [symbol] ”; the Chinese character structure of the rest of “ [symbol] ” which is removed the stroke “ [symbol] ”; the Chinese character structure formed by “ [symbol] ” which is added, near the stroke “ [symbol] ” of the “ [symbol] ”, a “ [symbol] ” or two “ [symbol] ” that intersect with the Oblique Hook, and which is removed the stroke “ [symbol] ”; etc.); obtain the “Oblique Hook” group structure, the Chinese character structure(s) which intersects (intersect) with the “Oblique Hook” group structure, and the Chinese character structure(s) which is (are) contained in the interval(s) that they (the “Oblique Hook” group structure and the Chinese character structure(s) which intersects (intersect) with the “Oblique Hook” group structure) intersect and then divide out, as a Chinese character structure group, to integrally keep (for instance, obtain “ [symbol] , [symbol] , [symbol] , [symbol] , [symbol] , [symbol] , [symbol] , [symbol] , or [symbol] ” to integrally keep. For Chinese character stroke order regulations of Japan, the Chinese character structure group can also not include the Chinese character structure which lies at the left edge of the interval, for instance, the stroke “ [symbol] ” of “ [symbol] or [symbol] ”.); when record the Chinese character structure group, the “Oblique Hook” group structure is after recording—for instance, the “Oblique Hook” group structure of “ [symbol] ” is recorded after “ [symbol] ” of “ [symbol] ” is recorded. 2. In the interval which the “beaded” structure or the “ [symbol] ” group structure divides out and which is at the upper-right corner, if it only contains a single stroke “ [symbol] ”, when record the “beaded” structure or the “ [symbol] ” group structure, the “ [symbol] ” is after recording (if the “ [symbol] ” is a part of the “Oblique Hook” group structure, process the “ [symbol] ” according to the “Oblique Hook” group structure.)—for instance, the “ [symbol] ” of “ [symbol] or [symbol] ” is after recording. 3. In the Chinese character structure which cannot be continued to split according to the Chinese character stroke order quickly determining method, the stroke “Lift” which intersects with other Chinese character structure(s) is after recording (if the Chinese character structure also contains a “Oblique Hook” group structure, first remove the “Oblique Hook” group structure; that is, the “Oblique Hook” group structure is recording later than the “Lift”.)—for instance, the “Lift” of “ [symbol] ” is recorded after having recorded the Chinese character structure which intersects with it; the stroke “ [symbol] ” which intersects with other Chinese character structure(s) is after recording—for instance, the “ [symbol] ” of “ [symbol] ” is recorded after having recorded the Chinese character structure which intersects with it; the stroke “Right Slope” (displayed in FIG. 10) is after recording—for instance, the “Right Slope” of “ [symbol] ” is recorded after having recorded “ [symbol] ”; . . . . For the Chinese character structures which contain the “Oblique Hook” group structure, the “Lift”, the “ [symbol] ”, or the “Right Slope”, can temporarily ignore the existence of the “Oblique Hook” group structure, the “Lift”, the “ [symbol] ”, or the “Right Slope” and continue to process according to the Chinese character stroke order quickly determining method, and determine the recording orders, for instance; “ [symbol] ” can be temporarily ignored the existence of the “Oblique Hook” group structure and continued to split into “ [symbol] , [symbol] , and [symbol] ”, and record the “Oblique Hook” group structure at the last. Another example, can also set up a rule: after processing according to the point i1, if the Chinese character structure group which is kept and which is the same left and right is composed of two character formation structures (namely Chinese character) juxtaposed left and right, process not according to the point i1 again when continue to split. For instance, “ [symbol] ” is composed of two character formation structures “ [symbol] ” juxtaposed left and right; first accord to the split rule A to split when split; do not process according to the point i1.

For different sets of Chinese character stroke order regulations, can set up different rules for tables of Chinese character stroke order special situation. For Chinese character stroke order regulations of Japan, if the like “ [symbol] ” group structure as shown in FIG. 80 (the Chinese character structure which 1 indicates in FIG. 80 can be a “ [symbol] ”, and can also be two “ [symbol] ”; the Chinese character structure which 2 indicates can be a “ [symbol] ”, and can also be two “ [symbol] ”; the “ [symbol] ” which 2 indicates is shorter than or equal to the “ [symbol] ” which 3 indicates; it is empty of strokes in the intervals which 4 and 5 indicate.) connects or intersects with the Chinese character structure(s) above the like “ [symbol] ” group structure (this rule can be further defined as: if the like “ [symbol] ” group structure connects with any one Chinese character structure of “ [symbol] ”, “ [symbol] ”, and the Chinese character structure displayed in FIG. 7 above the like “ [symbol] ” group structure, or intersects with any one Chinese character structure of “ [symbol] , [symbol] , [symbol] , and [symbol] ” above the like “ [symbol] ” group structure.), integrally keep this Chinese character structure group; the like “ [symbol] ” group structure is after recording when record this Chinese character structure group, and record according to the order as shown by reference signs with arrows in FIG. 80 (if 1 indicates two “ [symbol] ”, these two “ [symbol] ” are recorded according to the left one first and the right one after; if 2 indicates two “ [symbol] ”, these two “ [symbol] ” are recorded according to the above one first and the below one after.). So the recording orders of “ [symbol] , [symbol] , [symbol] , [symbol] , [symbol] , [symbol] , [symbol] , and [symbol] ” respectively are: [symbol] , [symbol] , [symbol] [symbol] , [symbol] , [symbol] , [symbol] and [symbol] .

For Chinese character stroke order regulations of mainland China, the like “ [symbol] ” structure means that the stroke “ [symbol] ” which 1 indicates and which is divided into two sections by the stroke “ [symbol] ” that 2 indicates in FIG. 80, the ratio of its upper section to its lower section is greater than 2, so the like “ [symbol] ” structure is obviously different from the Chinese character “ [symbol] ”; or means that the “ [symbol] ” which 3 indicates is obviously too long, so the like “ [symbol] ” structure is obviously different from the Chinese character “ [symbol] ” (the like “ [symbol] ” structure does not include the Chinese character structure as shown by the above part of the horizontal gap of “ [symbol] ”). So it contains the like “ [symbol] ” structure in each Chinese character of “ [symbol] , [symbol] , [symbol] , [symbol] , and [symbol] ”; it does not contain the like “ [symbol] ” structure in each Chinese character of “ [symbol] , [symbol] , [symbol] , [symbol] , and [symbol] ”. If the like “ [symbol] ” structure connects or intersects with the Chinese character structure(s) above the like “ [symbol] ” structure, integrally keep this Chinese character structure group; the like “ [symbol] ” structure is after recording when record this Chinese character structure group, and record according to the order as shown by reference signs with arrows in FIG. 80.

For the Chinese character structures which contain the like “ [symbol] ” group structure or the like “ [symbol] ” structure, can temporarily ignore the existence of the like “ [symbol] ” group structure or the like “ [symbol] ” structure and continue to process according to the Chinese character stroke order quickly determining method, and determine the recording orders.

In Japan, besides the standard Chinese character stroke orders teaching in schools, there are other nonstandard Chinese character stroke orders. Similarly, can set up rules for the tables of Chinese character stroke order special situation which correspond to the nonstandard Chinese character stroke orders; for example, the stroke “ [symbol] ” which is located in the center of a Chinese character structure and which runs through a plurality of strokes or most of the Chinese character structure is after recording when record the Chinese character structure (if this rule is incorporated into the point h2 of the supplementary description, need to indicate that this rule is prior to other rules of the point h2.)—for instance, the stroke “ [symbol] ” of “ [symbol] or [symbol] ” is recorded at the last.

In order to adapt to different sets of Chinese character stroke order regulations and achieve the best result, the rules which are set up for the table of Chinese character stroke order special situation and the rules of the supplementary description of the Chinese character stroke order quickly determining method can be transferred to each other. For example, in order to adapt to Chinese character stroke order regulations of Japan, can take the rule which relates to the like “ [symbol] ” group structure to include in the supplementary description of the Chinese character stroke order quickly determining method.

When the used information recording apparatus is a computer system which is equipped with a handwriting input function and a handwriting input device, you can use a light pen or a finger to record Chinese characters according to Chinese character stroke orders on the display screen of the computer system. When the used information recording apparatus is a computer system which is equipped with a mouse, you can use the mouse to write Chinese characters according to Chinese character stroke orders on the display screen of the computer system, or you can use the mouse to click on corresponding strokes which are displayed on the display screen of the computer system according to Chinese character stroke orders; if a plurality of coincident code Chinese characters are displayed on the display screen of the computer system after using the mouse to input a code, that is, strokes which are input according to the Chinese character stroke order of a Chinese character, select the Chinese character in the coincident code Chinese characters. When the used information recording apparatus is a computer system which is equipped with a keyboard, you can tap corresponding keys or code-keys of strokes of Chinese characters according to Chinese character stroke orders on the keyboard; if a plurality of coincident code Chinese characters are displayed on the display screen of the computer system after using the keyboard to input a code, that is, keys or code-keys of strokes which are input according to the Chinese character stroke order of a Chinese character, select the Chinese character in the coincident code Chinese characters.

### INDUSTRIAL APPLICABILITY

There are two situations when use an information recording apparatus to record Chinese character information. The first situation is that people whose mother tongue are recorded in Chinese characters first take years time to learn Chinese knowledge and a Chinese character information recording method and then have a job which relates to the Chinese character information recording by using an information recording apparatus. The second situation is that people whose mother —tongue are not recorded in Chinese characters, if encounter the situation that there are some Chinese character information needed to be recorded in work, learn a Chinese character information recording method and then use an information recording apparatus to record; if the work is important and plenty of, they will willingly take years time to learn a Chinese character information recording method; if not, they will more willingly give up such work; then the work will be delayed.

The technical solution provided by the present application can help Chinese character beginners who have no contact with Chinese characters (whether or not their mother tongues are recorded in Chinese characters) realize to record Chinese character information smoothly according to Chinese character stroke orders by using an information recording apparatus with a relatively low difficulty and a relatively short time.

What is claimed is:

1. A Chinese character information recording method, comprising:
1) a step for determining Chinese character strokes,
2) a step for determining Chinese character stroke orders, and
3) a step for recording Chinese characters according to the Chinese character stroke orders by using an information recording apparatus;
wherein said step for determining Chinese character stroke orders comprises:
2a) a step for determining Chinese character stroke orders according to a Chinese character stroke order quickly determining method and
2b) a step for determining Chinese character stroke orders by reference to a table of Chinese character stroke order special situation;
wherein said Chinese character stroke order quickly determining method comprises comparing a Chinese character structure with a split method from the first split rule of a sequence of split rules of said split method to the last split rule of the sequence of split rules of said split method and splitting the Chinese character structure into two parts according to the first suitable split rule of the sequence of split rules of said split method; comparing each of the two parts with said split method from the first split rule of the sequence of split rules of said split method to the last split rule of the sequence of split rules of said split method and splitting each of the two parts into two parts according to the first suitable split rule of the sequence of split rules of said split method; and so on, until the Chinese character structure cannot be continued to split according to said split method;
wherein said split method comprises a sequence of split rules:
split rule A. if a Chinese character structure contains a vertical gap which can be run through, obtaining a vertical line to run through the vertical gap of the Chinese character structure, the left part of the vertical line being a first recording part, the right part of the vertical line being an after recording part;
split rule B. if a Chinese character structure contains a horizontal gap which can be run through, obtaining a horizontal line to run through the horizontal gap of the Chinese character structure, the above part of the horizontal line being a first recording part, the below part of the horizontal line being an after recording part;
split rule C. if a Chinese character structure contains a turning gap which can be run through, obtaining a turning line to run through the turning gap of the Chinese character structure, the outside part of the turning line being a first recording part, the inside part of the turning line being an after recording part;
split rule D. if a Chinese character structure contains a turning potential gap which can be run through, obtaining a turning line to run through the turning potential gap of the Chinese character structure, the outside part of the turning line being a first recording part, the inside part of the turning line being an after recording part;
wherein said table of Chinese character stroke order special situation comprises:
Chinese character structures which are processed according to said Chinese character stroke order quickly determining method but determined stroke orders are different from standard stroke orders set by a standard setter and
basic Chinese character structures which are not processed according to said Chinese character stroke order quickly determining method.

2. The Chinese character information recording method of claim 1, wherein said information recording apparatus is a computer system which is equipped with a Chinese character input function and a keyboard;
wherein said step for recording Chinese characters according to the Chinese character stroke orders by using an information recording apparatus is tapping corresponding keys or code-keys of strokes of Chinese characters according to the Chinese character stroke orders on the keyboard; if a plurality of coincident code Chinese characters are displayed on the display screen of the computer system after using the keyboard to input a code, that is, keys or code-keys of strokes which are input according to a Chinese character stroke order of a Chinese character, selecting the Chinese character in the coincident code Chinese characters.

3. The Chinese character information recording method of claim 1, wherein said information recording apparatus is a tablet computer which is equipped with a Chinese character input function and a light pen which can be used to record characters on said tablet computer;
wherein said step for recording Chinese characters according to the Chinese character stroke orders by using an information recording apparatus is using said light pen or a finger to record Chinese characters according to the Chinese character stroke orders on said tablet computer.

4. The Chinese character information recording method of claim 1, wherein said information recording apparatus is a computer system which is equipped with a Chinese character input function and an input device.

5. The Chinese character information recording method of claim 1, wherein said Chinese character stroke order quickly determining method further comprises points a to i; wherein,
a. the horizontal lines referred to in the method comprise a slash “I”;
b. the turning lines referred to in the method mean that the turning lines have one and only one zigzag main body which turns around all or most of a part of a Chinese character structure; this part is “the inside part of the turning line”, and the other part of the Chinese character structure is “the outside part of the turning line”; both the inside part and the outside part of the turning line are not empty; do not obtain a turning line of which the zigzag main body is undistinguishable to split a Chinese character structure;
c. the “run through a . . . gap of a Chinese character structure” referred to in the method means that a split line which runs through a Chinese character structure does not cut off any one stroke, that the split line walks in a gap between two parts of a Chinese character structure from beginning to end, and that two ends of the split line can be forward extended without being blocked or connected to each other without being blocked; the “run through a . . . potential gap of a Chinese character structure” referred to in the method means that a split line which runs through a Chinese character structure does not cut off any one stroke, that the split line walks in a gap or a potential gap between two parts of a Chinese character structure from beginning to end, that two ends of the split line can be forward extended without being blocked or connected to each other without being blocked, and that the split line runs through at least one potential gap;
d. the vertical lines, the horizontal lines, the vertical sections of the turning lines, and the horizontal sections of the turning lines referred to in the method, some are straight; some are curve; some are wavy; do not deliberately turn the split lines when split;
e. in the outside part of the turning line, the stroke (strokes) completely below the inside part of the turning line is (are) recorded after the inside part of the turning line is recorded; if the outside part of the turning line contains the stroke (strokes) extending to the underside of the inside part of the turning line from the left side of the inside part of the turning line and there is (are) half or more than half a stroke (strokes) of the outside part of the turning line below the inside part of the turning line, the outside part of the turning line is recorded after the inside part of the turning line is recorded;
f. when obtain a split manner, a “Lift” and a “Hook” which are at the end of a stroke of a Chinese character structure can be ignored;
g. when obtain a vertical line or a horizontal line to split and there is more than one split manner, can obtain any one of them;
h. when obtain a turning line to split and there is more than one split manner, can skip this split rule and obtain another split manner in the follow-on split rules, or process as follows:
h1. a Chinese character structure contains a “ [symbol] ” group structure, and the “ [symbol] ” group structure divides the Chinese character structure out the left and the right two intervals; thus appears more than one split manner in which can obtain the turning line to split; process the Chinese character structure according to the “ [symbol] ” group structure;
h2. a Chinese character structure contains a “beaded” structure, and the “beaded” structure divides the Chinese character structure out the upper-left, the upper-right, the lower-left, and the lower-right four intervals; thus appears more than one split manner in which can obtain the turning line to split; process the Chinese character structure according to the “beaded” structure;
h3. a Chinese character structure contains a “ [symbol] ” group structure, and the “ [symbol] ” group structure divides the Chinese character structure out a plurality of intervals; thus appears more than one split manner in which can obtain the turning line to split; process the Chinese character structure according to the “ [symbol] ” group structure;
h4. for other situations, split according to a manner in which the inside part of the turning line can obtain a maximum area;
h5. in the “ [symbol] ” group structure, the “beaded” structure, and the “ [symbol] ” group structure, each component and each interior of the interval divided out represents a Chinese character structure; can separately list these Chinese character structures; continue to process them according to the Chinese character stroke order quickly determining method; and determine their recording orders.

6. The Chinese character information recording method of claim 1, wherein said table of Chinese character stroke order special situation further comprises a kind of after recording Chinese character structure which is after recording when record a Chinese character structure that is contained in said table of Chinese character stroke order special situation and that contains said kind of after recording Chinese character structure; and, for the Chinese character structure that is contained in said table of Chinese character stroke order special situation and that contains said kind of after recording Chinese character structure, temporarily ignore the existence of said kind of after recording Chinese character structure, continue to process the Chinese character structure according to said Chinese character stroke order quickly determining method, and determine its recording order.

7. The Chinese character information recording method of claim 1, wherein said split method further comprises a split rule E behind the split rule D, wherein the split rule E is: if a Chinese character structure contains a horizontal potential gap which can be run through, obtaining a horizontal line to run through the horizontal potential gap of the Chinese character structure, the above part of the horizontal line being a first recording part, the below part of the horizontal line being an after recording part.

8. The Chinese character information recording method of claim 1, wherein said split method further comprises a split rule C2 behind and next to the split rule C, wherein the split rule C2 is: if a Chinese character structure contains a horizontal potential gap which can be run through, obtaining a horizontal line to run through the horizontal potential gap of the Chinese character structure, the above part of the horizontal line being a first recording part, the below part of the horizontal line being an after recording part.

9. The Chinese character information recording method of claim 1, wherein said split method further comprises a split rule B2 behind and next to the split rule B, wherein the split rule B2 is: if a Chinese character structure contains a horizontal potential gap which can be run through, obtaining a horizontal line to run through the horizontal potential gap of the Chinese character structure, the above part of the horizontal line being a first recording part, the below part of the horizontal line being an after recording part.

10. The Chinese character information recording method of claim 1, wherein said split method further comprises a split rule A2 behind and next to the split rule A, wherein the split rule A2 is: if a Chinese character structure contains a horizontal potential gap which can be run through, obtaining a horizontal line to run through the horizontal potential gap of the Chinese character structure, the above part of the horizontal line being a first recording part, the below part of the horizontal line being an after recording part.

11. The Chinese character information recording method of claim 7, wherein said split method further comprises a split rule F behind the split rule E, wherein the split rule F is: if a Chinese character structure contains a vertical potential gap which can be run through, obtaining a vertical line to run through the vertical potential gap of the Chinese character structure, the left part of the vertical line being a first recording part, the right part of the vertical line being an after recording part.

12. The Chinese character information recording method of claim 8, wherein said split method further comprises a split rule F behind the split rule D, wherein the split rule F is: if a Chinese character structure contains a vertical potential gap which can be run through, obtaining a vertical line to run through the vertical potential gap of the Chinese character structure, the left part of the vertical line being a first recording part, the right part of the vertical line being an after recording part.

13. The Chinese character information recording method of claim 9, wherein said split method further comprises a split rule F behind the split rule D, wherein the split rule F is: if a Chinese character structure contains a vertical potential gap which can be run through, obtaining a vertical line to run through the vertical potential gap of the Chinese character structure, the left part of the vertical line being a first recording part, the right part of the vertical line being an after recording part.

14. The Chinese character information recording method of claim 10, wherein said split method further comprises a split rule F behind the split rule D, wherein the split rule F is: if a Chinese character structure contains a vertical potential gap which can be run through, obtaining a vertical line to run through the vertical potential gap of the Chinese character structure, the left part of the vertical line being a first recording part, the right part of the vertical line being an after recording part.

15. The Chinese character information recording method of claim 8, wherein said split method further comprises a split rule C4 before and next to the split rule D, wherein the split rule C4 is: if a Chinese character structure contains a vertical potential gap which can be run through, obtaining a vertical line to run through the vertical potential gap of the Chinese character structure, the left part of the vertical line being a first recording part, the right part of the vertical line being an after recording part.

16. The Chinese character information recording method of claim 9, wherein said split method further comprises a split rule C4 before and next to the split rule D, wherein the split rule C4 is: if a Chinese character structure contains a vertical potential gap which can be run through, obtaining a vertical line to run through the vertical potential gap of the Chinese character structure, the left part of the vertical line being a first recording part, the right part of the vertical line being an after recording part.

17. The Chinese character information recording method of claim 9, wherein said split method further comprises a split rule B4 before and next to the split rule C, wherein the split rule B4 is: if a Chinese character structure contains a vertical potential gap which can be run through, obtaining a vertical line to run through the vertical potential gap of the Chinese character structure, the left part of the vertical line being a first recording part, the right part of the vertical line being an after recording part.

18. A Chinese character information recording method, comprising:
1) a step for determining Chinese character strokes,
2) a step for determining Chinese character stroke orders, and
3) a step for recording Chinese characters according to the Chinese character stroke orders by using an information recording apparatus;
wherein said step for determining Chinese character stroke orders comprises:
2a) a step for determining Chinese character stroke orders according to a Chinese character stroke order quickly determining method and
2b) a step for determining Chinese character stroke orders by reference to a table of Chinese character stroke order special situation;
wherein said Chinese character stroke order quickly determining method comprises comparing a Chinese character structure with a split method from the first split rule of a sequence of split rules of said split method to the last split rule of the sequence of split rules of said split method and splitting the Chinese character structure into two parts according to the first suitable split rule of the sequence of split rules of said split method; comparing each of the two parts with said split method from the first split rule of the sequence of split rules of said split method to the last split rule of the sequence of split rules of said split method and splitting each of the two parts into two parts according to the first suitable split rule of the sequence of split rules of said split method; and so on, until the Chinese character structure cannot be continued to split according to said split method;
wherein said split method comprises a sequence of split rules:
split rule A. if a Chinese character structure contains a vertical gap which can be run through, obtaining a vertical line to run through the vertical gap of the Chinese character structure, the left part of the vertical line being a first recording part, the right part of the vertical line being an after recording part;
split rule B. if a Chinese character structure contains a horizontal gap which can be run through, obtaining a horizontal line to run through the horizontal gap of the Chinese character structure, the above part of the horizontal line being a first recording part, the below part of the horizontal line being an after recording part;
split rule C3. if a Chinese character structure contains a turning gap or a turning potential gap which can be run through, obtaining a turning line to run through the turning gap or the turning potential gap of the Chinese character structure, the outside part of the turning line being a first recording part, the inside part of the turning line being an after recording part;
wherein said table of Chinese character stroke order special situation comprises:
Chinese character structures which are processed according to said Chinese character stroke order quickly determining method but determined stroke orders are different from standard stroke orders set by a standard setter and
basic Chinese character structures which are not processed according to said Chinese character stroke order quickly determining method.

19. A Chinese character information recording method, comprising:
1) a step for determining Chinese character strokes,
2) a step for determining Chinese character stroke orders, and
3) a step for recording Chinese characters according to the Chinese character stroke orders by using an information recording apparatus;
wherein said step for determining Chinese character stroke orders comprises:
2a) a step for determining Chinese character stroke orders according to a Chinese character stroke order quickly determining method and
2b) a step for determining Chinese character stroke orders by reference to a table of Chinese character stroke order special situation;
wherein said Chinese character stroke order quickly determining method comprises comparing a Chinese character structure with a split method from the first split rule of a sequence of split rules of said split method to the last split rule of the sequence of split rules of said split method and splitting the Chinese character structure into two parts according to the first suitable split rule of the sequence of split rules of said split method; comparing each of the two parts with said split method from the first split rule of the sequence of split rules of said split method to the last split rule of the sequence of split rules of said split method and splitting each of the two parts into two parts according to the first suitable split rule of the sequence of split rules of said split method; and so on, until the Chinese character structure cannot be continued to split according to said split method;
wherein said split method comprises a sequence of split rules:
split rule A. if a Chinese character structure contains a vertical gap which can be run through, obtaining a vertical line to run through the vertical gap of the Chinese character structure, the left part of the vertical line being a first recording part, the right part of the vertical line being an after recording part;
split rule B3. if a Chinese character structure contains a horizontal gap or a horizontal potential gap which can be run through, obtaining a horizontal line to run through the horizontal gap or the horizontal potential gap of the Chinese character structure, the above part of the horizontal line being a first recording part, the below part of the horizontal line being an after recording part;
split rule C. if a Chinese character structure contains a turning gap which can be run through, obtaining a turning line to run through the turning gap of the Chinese character structure, the outside part of the turning line being a first recording part, the inside part of the turning line being an after recording part;
split rule D. if a Chinese character structure contains a turning potential gap which can be run through, obtaining a turning line to run through the turning potential gap of the Chinese character structure, the outside part of the turning line being a first recording part, the inside part of the turning line being an after recording part;
wherein said table of Chinese character stroke order special situation comprises:
Chinese character structures which are processed according to said Chinese character stroke order quickly determining method but determined stroke orders are different from standard stroke orders set by a standard setter and
basic Chinese character structures which are not processed according to said Chinese character stroke order quickly determining method.

20. A Chinese character stroke order determining diagram device for teaching prepared by the steps of:
a. splitting a Chinese character structure according to said Chinese character stroke order quickly determining method of any one of claims 1 or 5 to 19;
b. marking out the vertical line(s), the horizontal line(s), and the turning line(s) which is (are) involved in the split process and the split order in the Chinese character structure.
